(19) United States
(12) Patent Application Publication
(10) Pub. No.: US 2009/0262313 A1
(43) Pub. Date: Oct. 22, 2009

(54) Lamp module with AC burner for projectors

(75) Inventor: Henning Rehn, Nittendorf (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: OSRAM Gesellschaft mit beschrankter Haftung, Munchen (DE)

(21) Appl. No.: 12/383,014

(22) Filed: Mar. 19, 2009

(30) Foreign Application Priority Data
Apr. 18, 2008 (DE) 10 2008 019 648.7

(51) Int. Cl. G03B 21/28

(52) U.S. Cl. 353/98

(57) ABSTRACT

There is disclosed a lamp module, in particular for projectors for data or video projection, having at least one AC burner that is designed for AC operation, is inserted into a reflector and has a discharge vessel with two burner shafts, arranged diametrically relative to one another that carry a reflector electrode and a front electrode, it being possible for the light emitted by the AC burner to be fed to an optical system via the reflector. According to the invention, the front electrode has a large surface by comparison with the reflector electrode, such that said surface is more resistant to retroreflected light.

### TECHNICAL FIELD

The invention relates to a lamp module, in particular for projectors for data or video projection, having at least one AC burner that is designed for AC operation, is inserted into a reflector and has a discharge vessel with two burner shafts that carry a reflector electrode and a front electrode, it being possible for the light emitted by the burner to be fed to an optical system via the reflector.

### PRIOR ART

The market for digital projectors for data or video projection has been growing strongly globally since the invention of DLP technology. This increasing expansion is also based, inter alia, on the fact that the technologies used enable the projectors to be manufactured ever more cost-effectively and to be designed with such compact dimensions that it can be used in mobile fashion in everyday office life. In this case, solutions are required that in comparison to conventional designs retain the brightness on the screen as far as possible, that is to say enable the same electric power of the burner and a similar lighting efficiency of the lamp module for a given useful light. In the case of projection systems, use as light source is predominantly made of high pressure discharge lamps such as are described, for example, at www.osram.de under the designation of video and projection lamps (P-VIP-Lamps). These high pressure discharge lamps have a burner that is operated using alternating current (AC) and which is inserted into a reflector. When designing such high pressure discharge lamps, care must be taken that neither the reflector nor the AC burner are thermally damaged at the very high temperatures occurring. AC burners have the advantage for projection applications that, inter alia, the useful light drops less sharply as a rule over the service life than in the case of DC burners.

Such a lamp module is disclosed, for example in WO 2006/115180 A1. In this conventional solution, the burner is inserted into a reflector and has a discharge vessel with two burner shafts that carry a reflector electrode and a front electrode. The light emitted by the burner is fed to an optical system via the reflector. It is a disadvantage in the case of such lamp modules that, on optical systems assigned to the lamp module, for example a UV filter and a color wheel, reflected light is mostly retroreflected onto the front electrode such that the latter is additionally heated up. This results in a reduced service life of the high pressure discharge lamp in the projector. Furthermore, during burning the electrodes of such lamps often experience in the projector a transformation exhibiting intermittent negative accompanying phenomena such as, for example, temporal fluctuations in the light intensity (flickering).

### SUMMARY OF THE INVENTION

It is the object of the invention to provide a lamp module that has an AC burner and exhibits a better resistance to the effects of the light retroreflected into the lamp, and an improved service life.

This object is achieved by a lamp module, in particular for projectors for data or video projection, having at least one AC burner that is designed for AC operation, is inserted into a reflector and has a discharge vessel with two burner shafts that carry a reflector electrode and a front electrode, it being possible for the light emitted by the AC burner to be fed to an optical system via the reflector, the front electrode having a large surface by comparison with the reflector electrode. Particularly advantageous designs of the invention are described in the dependent claims.

It has emerged that it is advantageous for a stable operation and a long service life of the burner when both electrodes are held at a specific temperature during operation. Since because of the alternating current direction it is the case with AC burners that the two electrodes are heated up equally strongly on average, both electrodes are normally also of the same size.

However, it has also been shown that during the operation of a lamp module with an AC burner in a projector one electrode of the AC burner is more strongly heated up by the light retroreflected at the optical components of the projector.

In the case of the inventive solution, the heating by retroreflected light is substantially compensated by the enlarged front electrode and, consequently, the stronger radiation cooling thereof, so that the maximum efficiency and service life of the lamp module is ensured. The reflector electrode is conventionally designed according to power, electrode spacing etc.

In accordance with a particularly preferred exemplary embodiment of the invention, the surface of the front electrode is enlarged in such a way that the temperature Tₑₗ of the two electrodes is substantially the same in accordance with the Stefan-Boltzmann formula P=A·σ·Tₑₗ⁴. Tests show, for example, that up to 10% of the light emitted by the burner is retroreflected onto the front electrode at the downstream optical system, for example a UV filter and a color wheel of a projector. Consequently, P rises by approximately 40% such that the absolute electrode temperature of the front electrode rises by about 9% for the same surface A. This corresponds to a temperature rise of approximately 270 K given a temperature of 3000 K. According to the invention, the front electrode is enlarged, the emitting surface of the electrode rising by approximately 40% in this example such that the temperature of the front electrode remains unchanged by comparison with an arrangement without retroreflection.

The surface of the front electrode is preferably designed to be larger in the range from approximately 10 to 60% than that of the reflector electrode.

It has proved to be particularly advantageous in terms of production engineering when by comparison with the reflector electrode the front electrode has a larger electrode head, a larger number of windings, a thicker winding wire and/or a thicker core pin.

The AC burner is, preferably designed as a high pressure discharge lamp designed for AC operation, in particular as an AC mercury high pressure discharge lamp.

The invention can be applied with particular advantage in the case of lamp modules with an elliptical reflector.

### BRIEF DESCRIPTION OF THE DRAWINGS

The invention is explained in more detail below with the aid of a preferred exemplary embodiment. In the drawing:

FIG. 1 shows a side view of an inventive lamp module, and

FIG. 2 shows an enlarged illustration of the lamp module from FIG. 1 in the region of the electrodes.

### PREFERRED DESIGN OF THE INVENTION

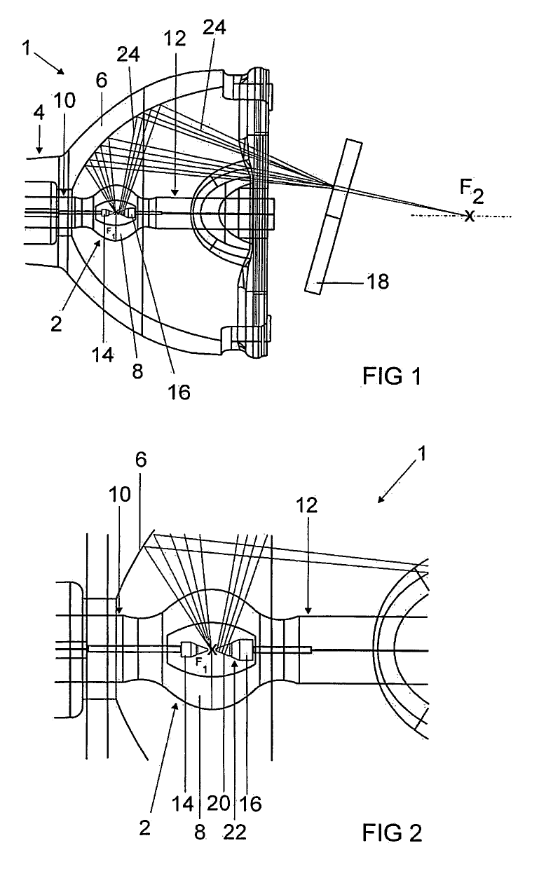

In accordance with FIG. 1, the inventive lamp module 1 has a schematically illustrated AC burner 2 that is inserted into a reflector neck 4 of a reflector 6, and has a discharge vessel 8 with two burner shafts 10, 12 that carry a reflector electrode 14 and a front electrode 16. The reflector 6 is designed as an ellipsoid in the exemplary embodiment illustrated. With the reflector 6, the AC burner 2 designed as a high pressure discharge lamp for AC operation forms a preassembled unit that can be inserted into a projector (not illustrated), for example a digital projector for data or video projection with DLP/DMD or LCD technology. The discharge vessel 8 of the AC burner 2 is arranged inside the reflector 6 in such a way that the discharge arc produced lies at a focal point F₁ of the reflector 6, or in the immediate vicinity thereof. The light generated in the discharge vessel 8 by the discharge arc is projected by the reflector 6 onto the secondary focus F₂ and coupled there into the optical system of the projector. A filter 18 is provided to protect the projector against UV and/or IR light. In accordance with the schematically indicated ray path 24, the light reflected at the filter 18 is for the most part retroreflected onto the front electrode 16, and could damage the latter.

As is to be gathered, in particular, from FIG. 2, which shows an enlarged illustration of the lamp module 1 from FIG. 1 in the region of the electrodes 14, 16, for this reason the front electrode 16 has—as distinct from a conventional AC burner—an emitting surface 20 that is enlarged by comparison with the reflector electrode 14, thus substantially compensating for the heating owing to light retroreflected by the optical system 18 (see FIG. 1). The maximum efficiency and service life of the lamp module 1 is thereby ensured. The emitting surface 20 of the front electrode 16 is enlarged in such a way that the temperature of the two electrodes 14,16 is substantially the same in accordance with the Stefan-Boltzmann formula P=A·σ·Tₑₗ⁴. In accordance with the exemplary embodiment illustrated, the emitting surface 20 is enlarged by approximately 40% such that the temperature of the front electrode 16 remains unchanged compared to a situation without retroreflection. It has proved to be particularly advantageous in terms of production engineering when the front electrode 16 has a larger electrode head 22 than the reflector electrode 14. The reflector electrode 14 is designed conventionally as regards power, electrode spacing etc.

In the case of an exemplary embodiment (not illustrated) of the invention with a front electrode produced by using winding technology, the enlarged emitting surface is achieved by means of a larger number of windings, a thicker winding wire and/or a thicker core pin.

The inventive lamp module 1 with AC burner is not restricted to the exemplary embodiment illustrated for projectors—rather, the lamp module 1 can be used for different applications known from the prior art in the case of which light is required for an optical system.

What is disclosed is a lamp module 1 with an AC burner, in particular for projectors for data or video projection, with at least one burner 2 that is inserted into a reflector 6 and has a discharge vessel 8 with two burner shafts 10, 12 that are arranged diametrically in relation to one another and carry a reflector electrode 14 and a front electrode 16, it being possible for the light emitted by the AC burner 2 to be fed to an optical system 18 via the reflector 6. According to the invention, the front electrode 16 has a large surface 20 by comparison with the reflector electrode.

1. A lamp module, having at least one AC burner (2) that is designed for AC operation, is inserted into a reflector (6) and has a discharge vessel (8) with two burner shafts (10, 12) that carry a reflector electrode (14) and a front electrode (16), it being possible for the light emitted by the AC burner (2) to be fed to an optical system (18) via the reflector (6), characterized in that the front electrode (16) has a large surface (20) by comparison with the reflector electrode (14).

2. The lamp module as claimed in claim 1, in which the surface (20) of the front electrode (16) is enlarged in such a way that the temperature of the two electrodes (14, 16) is substantially the same in accordance with the Stefan-Boltzmann formula P=A·σ·Tₑₗ⁴.

3. The lamp module as claimed in claim 1 or 2, in which the surface (20) of the front electrode (16) is designed to be larger in the range from approximately 10 to 60% than that of the reflector electrode (14).

4. The lamp module as claimed in claim 1 or 2, in which by comparison with the reflector electrode (14) the front electrode (16) has a larger electrode head (22), a larger number of windings, a thicker winding wire and/or a thicker core pin.

5. The lamp module as claimed in claim 1 or 2, in which the optical system has at least one UV filter (18) and/or a color wheel.

6. The lamp module as claimed in claim 1 or 2, in which the reflector (6) is a partially elliptical reflector.

7. The lamp module as claimed in claim 1 or 2, in which the AC burner (2) is a high pressure discharge lamp designed for AC operation, in particular an AC mercury high pressure discharge lamp.

8. The lamp module as claimed in claim 1 or 2 for a data or video projector.
